(19) United States
(12) Patent Application Publication
(10) Pub. No.: US 2021/0283533 A1
(43) Pub. Date: Sep. 16, 2021

(54) Liquid Filter

(71) Applicant: MANN+HUMMEL GmbH, Ludwigsburg (DE)

(72) Inventors: Alexander Traut, Bad Rodach (DE); Marius Panzer, Ludwigsburg (DE)

(21) Appl. No.: 17/334,777

(22) Filed: May 30, 2021

Related U.S. Application Data
(63) Continuation of application No. PCT/EP2019/083048, filed on Nov. 29, 2019.

(30) Foreign Application Priority Data
Nov. 30, 2018 (DE) 10 2018 130 552.4

(51) Int. Cl. B01D 29/03; B01D 35/30; F16H 57/04

(52) U.S. Cl. CPC B01D 29/031; B01D 35/30; B01D 2201/60; B01D 2201/122; B01D 2201/301; F16H 57/0404

(57) ABSTRACT

A liquid filter has inflow and outflow faces connected by a throughflow path. A one-piece filter body of a folded filter medium bellows is provided. Each fold has first and second fold sheets joined at a fold edge and two fold end faces. The filter body is installed into a pre-defined installation space of a vehicle, the installation space defined and delimited by a base free-form surface, a cover free-form surface, and a side free-form surface. The fold edge heights of the folds are adapted to a contour of cover free-form surface; base free-form surface; or cover and base free-form surfaces. First folds with first fold edge height and second folds with second fold edge height that differ from each other are provided. Third folds have fold end faces adapted to a contour of the side free-form surface facing these fold end faces. An envelope around all fold end faces and rim folds deviates from a rectangle.

### CROSS-REFERENCE TO RELATED APPLICATIONS

This application is a continuation application of international application No. PCT/EP2019/083048 having an international filing date of 29 Nov. 2019 and designating the United States, the international application claiming a priority date of 30 Nov. 2018 based on prior filed German patent application No. 10 2018 130 552.4, the entire contents of the aforesaid international application and the aforesaid German patent application being incorporated herein by reference.

### BACKGROUND OF THE INVENTION

The invention concerns a liquid filter, in particular an oil filter, for filtering a liquid, in particular an oil, which comprises a raw-side inflow face and a clean-side outflow face, connected to each other by means of a throughflow path, and a filter body comprising a filter medium folded to a folded bellows with a plurality of folds, wherein each fold comprises a fold edge height and two oppositely positioned fold end faces, and wherein the folded bellows is configured to be installed in an installation space that delimits an installation space volume by means of a base free-form surface, a cover free-form surface, and a side free-form surface.

Such liquid filters are known. These are liquid filters that are employed for filtration of liquids. The liquid can be, for example, oil or fuel. In this context, the liquid filter will be installed in a filter assembly that can be used, for example, in internal combustion engines.

For purposes of filtering, the liquid to be filtered (raw liquid) is guided via the throughflow path to the raw-side inflow face of the liquid filter. In the throughflow direction, the filter body is arranged downstream of the raw-side inflow face. It is formed of the folded bellows with the filter medium that is folded such that it comprises a plurality of folds across which the liquid to be filtered is guided. In this context, the folds of the folded bellows each have a fold edge height and two fold end faces that are each arranged perpendicularly to the throughflow direction of the liquid to be filtered. After completed filtering of the liquid (clean liquid), the clean liquid exits then at the clean-side outflow face from the liquid filter. It can then be supplied to its further use.

Such a liquid filter is installed in an installation space through which the liquid (raw liquid) to be filtered is guided. The installation space is typically adapted to the external requirements of those constructive structures in which it is positioned. These structures can be, for example, an internal combustion engine. Depending on the constructive requirements in regard to such installation spaces, their configuration will be very different. In general, it will deviate from simple geometric shapes, such as cuboids or the like. Such an installation space is therefore delimited or defined by means of a base free-form surface, a cover free-form surface, and a side free-form surface. These mentioned surfaces can deviate from simple geometric basic shapes, such as rectangles, triangles or the like. In this context, the folded bellows is arranged on the base free-form surface so that the fold edges extend from the base free-form surface in the direction toward the cover free-form surface. The fold edge height is then the height of the fold edges above the base free-form surface. Moreover, the fold end faces extend parallel to an extension of the side free-form surface from the base free-form surface in the direction toward the cover free-form surface.

The folded bellows of the filter body comprises a folded bellows base surface. This folded bellows base surface is arranged on the base free-form surface. In this context, it is known to embody the folded bellows base surface of a rectangular shape. The dimensions of this rectangular shape are then adapted to the base free-form surface such that the folded bellows in its rectangular shape is accommodated on the base free-form surface. The same holds true for the fold edge heights. They are all adjusted such that they comprise an identical fold edge height across the folded bellows base surface which at most corresponds to a smallest distance from cover free-form surface to base free-form surface in the installation space. In this way, the folded bellows or the liquid filter can be accommodated in the installation space volume.

In this arrangement of the liquid filter, certain installation space sections however remain unused in case of an installation space deviating from a simple geometric basic shape, such as a cuboid, insofar as no filter medium is arranged therein. This results in misshapen liquid filters in the aforementioned installation spaces. They utilize the existing installation space badly and therefore provide only a minimal filtration efficiency.

### SUMMARY OF THE INVENTION

It is therefore the object of the invention to provide a liquid filter that optimally utilizes an existing installation space volume and therefore provides a high filtration efficiency. Also, an inexpensive manufacture with as few components as possible is to be achieved. Moreover, an advantageous use is to be disclosed.

This object is solved by a liquid filter, in particular oil filter, for filtering a liquid, in particular an oil, comprising a raw-side inflow face and a clean-side outflow face, connected to each other by means of a throughflow path, and a filter body which comprises a filter medium folded to a folded bellows with a plurality of folds and extending between two rim folds, wherein each fold comprises a first fold sheet and a second fold sheet adjoining each other at a fold edge, a fold edge height, and two oppositely positioned fold end faces, and wherein the liquid filter is configured to be installed in an installation space that delimits an installation space volume by means of a base free-form surface, a cover free-form surface, and a side free-form surface, wherein the liquid filter is characterized in that the folded bellows is of a one-piece configuration and at least two of the plurality of folds comprise a different height, wherein the fold edge heights are adapted to an uneven or slanted course of the contour of the cover free-form surface and/or of the base free-form surface, and wherein the fold end faces of at least two folds are adapted to a course of the contour of the side free-form surface facing it, wherein the shape of an envelope of all fold end faces and of the rim folds deviates from a rectangle.

Further embodiments of the invention are disclosed in the dependent claims.

The liquid filter according to the invention comprises a folded bellows of folded filter medium with a plurality of folds. Each fold comprises a first and a second fold sheet which adjoin each other at a fold edge. Neighboring folds of the folded bellows also adjoin each other with their lateral edges at a fold edge. The respective first fold sheets of neighboring folds are positioned substantially parallel to each other. The fold sheets extend between an inflow face and an outflow face. The end faces of the folds extend substantially perpendicularly to the inflow face and outflow face. Within a fold, the fold height is constant, i.e., the fold height of the bellows can change in fold direction but not in the direction along the fold edges. In the liquid filter according to the invention, the folded bellows is of a one-piece configuration and at least two fold edge heights of the plurality of folds are adapted to a course of the contour of the cover free-form surface or the base free-form surface. The extension of the contour of the cover free-form surface is illustrated by the course of a connecting line of a plurality of selected points on the cover free-form surface as a function of the perpendicular distance of corresponding points on the base free-form surface. The same applies to the base free-form surface. The base free-form surface and/or the cover free-form surface is positioned at a slant in this context or is uneven, i.e., it comprises at least one incline, curvature and/or step. When one of the two aforementioned surfaces is flat and the other surface is not, the distance between these two surfaces varies.

The fold edge height of the folded bellows is thus variable within the folded bellows. Different fold edge heights in a one-piece folded bellows can be present. In this way, the fold edge height can be adapted flexibly to the existing installation space. The fold edge height is adapted in this context to the height of the installation space (the perpendicular distance between a point on the base free-form surface and a point on the cover free-form surface). In this way, the existing installation space is covered in its height optimally by the adjustment of the fold edge height to the installation space height. A better filtering efficiency can be achieved, in particular by the possibility of reducing the pressure loss by means of a larger filter surface area. At the same time, the separation efficiency can be increased. In this way, an increased separation efficiency can also be achieved by the use of a filter medium with a higher separation with an unchanged pressure loss in comparison with a liquid filter of a conventional configuration. The larger filter surface area provides also the possibility of prolonging the service life or the service interval of the liquid filter. Also, installation and attachment parts can be integrated better by adaptation of the fold edge height to the conditions of the cover free-form surface or the base free-form surface.

In this context, it is advantageous that the folded bellows comprises at least two folded bellows sections with a different fold edge height that are configured to leave unoccupied a respective predetermined distance from the cover free-form surface section in at least two cover free-form surface sections of the cover free-form surface.

The cover free-form surface can be composed of two or more different cover free-form surface sections. These different cover free-form surface sections can each comprise a height above the base free-form surface that are different from each other. The folded bellows of the liquid filter takes into account these conditions of the installation space by means of the configuration of the folded bellows sections corresponding to the cover free-form surface sections. The fold edge height in each folded bellows section is adapted individually to the available installation space height. This is achieved in that a respective predetermined distance in each folded bellows section between the respective fold edges and the cover free-form surface is left unoccupied. The distance between the fold edges and the cover free-form surface thus follows the shape of the cover free-form surface; in this context, the distance can be constant but also, in accordance with the conditions of the cover free-form surface, can vary also within a cover free-form surface section. The distance, depending on the requirements, for example, the integration of installation or attachment parts, can be varied. The existing installation space volume is optimally utilized. In case that the filter element is installed in a housing with an inflow-side housing cover, the cover preferably emulates the shape of the cover free-form surface. Alternatively, the cover can follow the course of the inflow face.

It is therein preferred that a distance between two neighboring first fold edges in a folded bellows transition section between the two folded bellows sections is different from a distance between two neighboring second fold edges in a folded bellows section.

Accordingly, not only the fold edge height is adapted to the existing installation space but also (additionally) the folding of the filter medium is varied in accordance with the conditions of the installation space. In this way, also edges, steps or the like which are existing in the base free-form surface can be covered optimally with the filter medium. The folds can simply “bridge” such edges or steps by means of the variation of the distance between the individual fold edges.

In the liquid filter according to the invention, at least two fold end faces are alternatively or additionally adapted to a course of the contour of the side free-form surface facing them. The side free-form surface deviates from a standard rectangular shape and can optionally comprise at least one curved side free-form surface section. The contour of the side free-form surface is illustrated by the course of a connecting line of a plurality of selected points on a first side free-form surface as a function of the perpendicular distance of corresponding points on the side free-form surface positioned opposite thereto.

Accordingly, the course of a circumferential contour of the folded bellows can be adapted to the course of the side free-form surface. The fold end faces follow the course of the side free-form surface along its course even when the side free-form surface is curved, i.e., comprises a curved side free-form surface section. In this way, a variable fold length is provided. The contour of the envelopes of all end faces at one side can deviate from the contour of the envelopes of all end faces at the other side. Thus, the folded bellows base surface emulates or reproduces the base free-form surface.

The base free-form surface is optimally utilized and (almost) completely covered by the filter medium. The folded bellows base surface deviates from the conventional rectangular shape and can be adapted flexibly to the existing base free-form surface. A better filtering efficiency can be achieved, in particular by the possibility of reducing the pressure loss by a larger filter surface area. At the same time, the separation efficiency can be increased. In this way, an increased separation efficiency can also be achieved by the use of a filter medium with a higher separation with an unchanged pressure loss in comparison with a liquid filter of a conventional configuration. The larger filter surface area provides also the possibility of prolonging the service life or the service interval of the liquid filter. Also, installation and attachment parts can be better integrated by adaptation of the folded bellows base surface to the conditions of the base free-form surface.

It is advantageous that in addition the at least two fold edge heights of the plurality of folds are adapted to the course of the contour of the cover free-form surface. The course of the contour of the cover free-form surface is illustrated by the course of a connecting line of a plurality of selected points on the cover free-form surface as a function of the perpendicular distance of corresponding points on the base free-form surface.

Also, the fold edge height of the folded bellows is thus variable within the folded bellows. Different fold edge heights may be provided in a one-piece folded bellows. In this way, the fold edge height can be adapted flexibly to the existing installation space. The fold edge height is adapted in this context to the height of the installation space (the perpendicular distance between a point on the base free-form surface and a point on the cover free-form surface). In this way, the existing installation space is covered additionally in its height optimally by the adjustment of the fold edge height to the installation space height. A better filtering efficiency can be achieved, in particular by the possibility of additionally reducing the pressure loss by a larger filter surface area. At the same time, the separation efficiency can be additionally increased. This can be achieved also by the use of a filter medium with a higher separation with unchanged pressure loss in comparison with a liquid filter of a conventional configuration. The larger filter surface area provides also the possibility of prolonging the service life or the service interval of the liquid filter. Also, installation and attachment parts can be additionally integrated optimally by the additional adjustment of the fold edge heights to the conditions of the cover free-form surface.

The folded bellows is preferably introduced into a housing pot with a sidewall and a bottom surface. In order to optimally utilize the installation space, the shape of the sidewall corresponds to the shape of the side free-form surface and the shape of the bottom surface corresponds to the shape of the base free-form surface. The housing pot can remain open or can be closed by a housing cover. The shape of the housing cover is preferably adapted to the shape of the cover free-form surface. In this context, it is advantageous when the housing cover covers a portion of the inflow face as minimal as possible. For this purpose, the cover can comprise a plurality of openings, for example, can be embodied as a grid. The cover can be connected detachably or non-detachably to the housing pot. The folded bellows can be connected with the rim sides and the end faces to the housing pot. A section of the rim folds can be compressed between housing pot and cover.

In all of this, it is preferred that at least one fold at the raw-side inflow face and/or at the clean-side outflow face and/or at least one fold end face is fastened by means of clamping, compressing, gluing or welding to the sidewall of the filter pot, respectively.

In a folded bellows of a one-piece configuration, it is thus possible to dispense with an attachment of the folded bellows in the housing by means of embedding by injection molding. The filter body can be assembled or framed, for example, by glued-on side bands. By means of a joining process (e.g., gluing, welding etc.), the filter element with flexible configuration can then be put together and installed in the housing. When the folded bellows is fastened fixedly in the filter pot, a housing cover can be dispensed with.

Also, it is advantageous that the folded bellows is formed continuously of a single material.

The manufacture of such a one-piece folded bellows is possible inexpensively and efficiently.

The one-piece filter bellows is preferably embodied of a so-called deep filtration filter medium. Suitable such filter media are preferably wet-laid or dry-laid randomly oriented fiber materials which are mechanically and/or chemically reinforced. Such a randomly oriented fiber material comprises hollow spaces between the fibers. The filter medium can comprise natural fibers and at least a proportion of synthetic fibers, for example, polyethylene terephthalate (PET) and/or glass fibers whose proportion can be selected so as to be adapted to the respective filtration application. The proportion can be, for example, a proportion of greater than 10% by weight. The filter medium can also be comprised of synthetic fibers and/or glass fibers wherein, in case of a mixture of synthetic fibers and glass fibers, the mixture ratio can be adaptively selected for the respective filtration application.

The filtration medium can be embodied as a single layer or as multiple layers; for example, a so-called two-substance poured material but also a multi-substance poured material can be selected. In case of a two-substance but also a multi-substance poured material, a fiber slurry of a predetermined fiber type or of a predetermined mixture of fiber types is poured onto a prior formed or still forming nonwoven. The basic laid fiber product may comprise in particular additional layers which can be joined by, for example, material-fusing, in particular thermal, joining methods, for example, by lamination or ultrasonic welding.

Preferably, in case of a two-layer or multi-layer configuration, the clean side layer or the clean side and the raw side layers, in other words one or the respective outer layer, can be formed as a grid structure (drainage grid). This stabilizes the overall configuration additionally and ensures that the fold position in the situation of use remains in position in an optimized manner. The thickness of the filter medium can amount to, for example, between 0.3 mm to 5 mm. The air permeability preferably amounts to between 200 l/m²s to 3,000 l/m²s.

Synthetic or glass fiber media are preferred for so-called lifetime (length of life) applications such as, for example, transmission oil filtration.

Finally, it is preferred that the fold edge height lies in a range between 2 mm to 100 mm, preferably 4 mm to 80 mm, particularly preferred between 8 mm and 50 mm.

Not least, it is preferred that the liquid filter is configured as a suction-side transmission oil filter. In this way, the performance of oil management in a motor can be improved.

Alternatively, the liquid filter according to the invention is employed in a “pressureless” system, i.e., in a system without pump. In this context, the liquid is not forced by pressure or sucked through the filter, but the liquid passes through the filter medium, following the force of gravity. Due to the optimal installation space utilization, the pressure loss across the filter is particularly minimal so that it is suitable particularly well for the pressureless use, i.e., without pump.

The liquid filter according to the invention is used particularly advantageously in an E-axle of a motor vehicle. The E-axle combines motor, transmission, axle, and power electronics in one component and is used in vehicles with electric drive or hybrid drive. The transmission is supplied with transmission oil wherein some components require a defined purity of the oil. The liquid filter according to the invention filters the transmission oil. The unpurified oil is supplied to the inflow face of the liquid filter, trickles through the filter medium to the bottom of the filter pot, and exits the latter through one or a plurality of outlets. The filtered transmission oil is then supplied to the corresponding components.

### BRIEF DESCRIPTION OF THE DRAWINGS

Further advantages result from the following drawing description. In the drawings, embodiments of the invention are illustrated. The drawings, description, and claims contain numerous features in combination. A person of skill in the art will consider the features expediently also individually and combine them to expedient further combinations.

FIG. 1 shows a first embodiment of a liquid filter according to the invention in a first installation space.

FIG. 2 shows a second embodiment of a liquid filter according to the invention in a second installation space.

FIG. 3 shows a third embodiment of a liquid filter according to the invention in a third installation space.

FIG. 4 shows a fourth embodiment of a liquid filter according to the invention for a fourth installation space.

FIG. 5 shows a section view of the embodiment according to FIG. 4.

FIG. 6 shows a perspective view of a fifth embodiment of a liquid filter according to the invention for a fifth installation space.

FIG. 7 shows a plan view of the embodiment according to FIG. 6.

FIG. 8 shows a section view of the embodiment according to FIG. 7.

FIG. 9 shows a perspective view of a sixth embodiment of a liquid filter according to the invention for a sixth installation space.

FIG. 10 shows a plan view of the embodiment according to FIG. 9.

FIG. 11 shows a section view of the embodiment according to FIG. 10.

FIG. 12 shows a perspective view of an embodiment of a liquid filter for a seventh installation space.

FIG. 13 shows a plan view of the embodiment according to FIG. 12.

FIG. 14 shows a section view of the embodiment according to FIG. 13.

FIG. 15 shows a perspective view of an embodiment of a liquid filter for an eighth installation space.

FIG. 16 shows a plan view of the embodiment according to FIG. 15.

FIG. 17 shows a section view of the embodiment according to FIG. 16.

FIG. 18 shows a perspective view of an embodiment of a liquid filter for a ninth installation space.

FIG. 19 shows a plan view of the embodiment according to FIG. 18.

FIG. 20 shows a section view of the embodiment according to FIG. 19.

FIG. 21 shows a perspective view of a liquid filter with filter pot and cover grid.

### DESCRIPTION OF PREFERRED EMBODIMENTS

The Figures show only examples and are not to be understood as limiting.

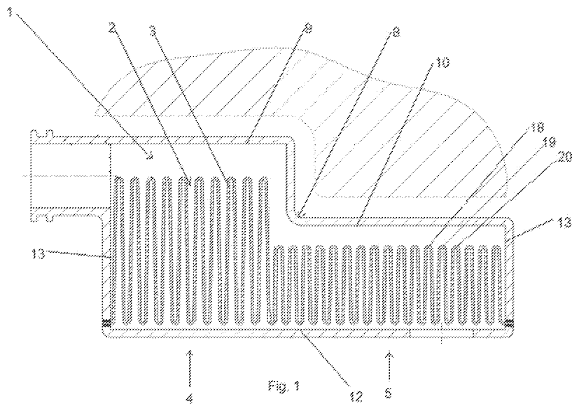

FIG. 1 shows a liquid filter 1. The liquid filter 1 comprises a folded bellows 2 which is formed of a plurality of folds 3 which are provided in a filter medium. The liquid filter 1 comprises moreover a housing in which the folded bellows 2 is inserted. The housing is comprised preferably of plastic material and can be an injection molded part. The folded bellows 2 is fixedly connected to the housing, for example, glued thereto. Should an exchange be required, the entire liquid filter with housing is thus exchanged. Alternatively, the filter bellows 2 can also be exchangeably arranged in the filter housing.

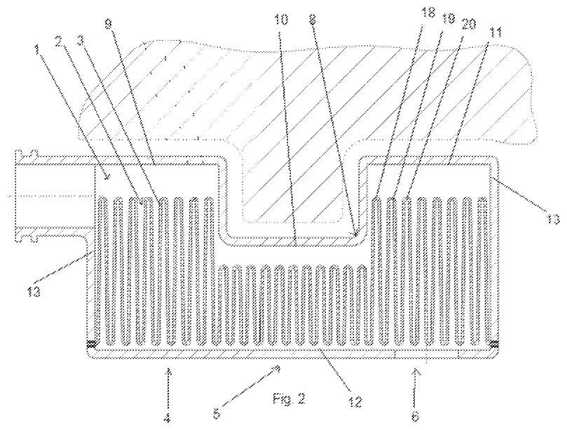

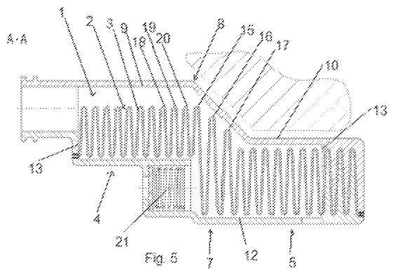

Moreover, one can see in FIG. 1 that the folded bellows 2 is formed of a first folded bellows section 4 and a second folded bellows section 5. Also, a third folded bellows section 6 can be provided (compare instantly FIG. 2). Generally speaking, the folded bellows 2 can thus be combined of an arbitrary number of different folded bellows sections. These different folded bellows sections can be connected to each other by folded bellows transition sections as is shown in an exemplary fashion by the folded bellows transition section 7 (compare instantly FIG. 5).

In a direction of force of gravity, the liquid filter 1 is limited in its extension toward the top by a housing cover with a cover free-form surface 8. The configuration of this cover free-form surface 8 depends on the installation space that is available in the application. It will therefore in general deviate from simple geometric basic shapes such as rectangles or the like. In the example of FIG. 1, the cover free-form surface 8 is embodied of a first cover free-form surface section 9 and a second cover free-form surface section 10. Likewise, for example, a third cover free-form surface section 11 can be provided (compare instantly FIG. 2). Generally speaking, the cover free-form surface 8 can thus be combined of an arbitrary number of different cover free-form surface sections. These cover free-form surface sections can be connected to each other by cover free-form surface transition sections.

It can be seen in FIG. 1 that the fold edge height above a base free-form surface 12 can be designed differently. In the first cover free-form surface section 9 in which the first folded bellows section 4 is arranged, a first fold edge height is provided that is adapted to an installation space height in the first cover free-form surface section 9. Moreover, in the second cover free-form surface section 10 in which the second folded bellows section 5 is arranged, a second fold edge height is provided which is adapted to an installation space height in the second cover free-form surface section 10. The distance of the fold edges from the cover free-form surface is different in the first folded bellows section 4 and the second folded bellows section 5, respectively, but is constant within the respective folded bellows section 4, 5. The filter bellows 2 is of a one-piece configuration but comprises different filter bellows sections 4, 5 with different fold edge heights. The fold edge height can be variable within the folded bellows 2; folds 3 with different fold edge heights can be present. The folded bellows 2 can thus be adapted flexibly to the existing installation space.

In FIG. 2, a similar second embodiment is shown. Here, a total of three different folded bellows sections 4, 5, 6 are provided in three different cover free-form surface sections 9, 10, 11. It can again be seen that the fold edge heights in the different folded bellows sections 4, 5, 6 are adapted to the height of the cover free-form surface sections 9, 10, 11. For this purpose, in the first folded bellows section 4 and in the third folded bellows section 6, identical fold edge heights are provided, respectively; in the second folded bellows section 5, a different fold edge height is provided which is smaller than the fold edge height in the first folded bellows section 4 and the third folded bellows section 6. Again, the folded bellows 2 is flexibly adapted to the installation space.

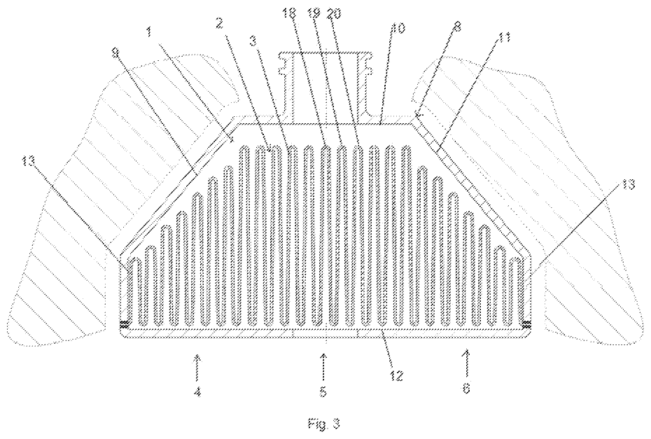

In FIG. 3, an again similar embodiment is shown. Here, it can be seen in particular that the one-piece folded bellows 2 comprises a plurality of different fold edge heights that follow the course of the cover free-form surface 8. In this way, a folded bellows 2 with a trapezoidal cross section results which is optimally adapted to the existing installation space. In this context, it can also be seen in particular that the fold edge height can even vary within folded bellows sections, for example, here the first folded bellows section 4 and the third folded bellows section 6, in order to be adapted to the existing installation space.

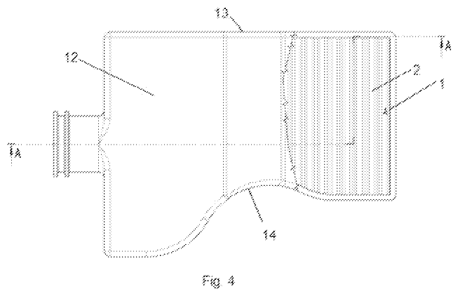

In FIG. 4, a further embodiment of a liquid filter 1 is illustrated. Here, the base free-form surface 12 is delimited by means of a side free-form surface 13 which comprises a curved side free-form surface section 14. The shape of the filter housing corresponds to the shape of the installation space, i.e., the base free-form surface corresponds to the shape of the bottom surface of the housing and the side free-form surface corresponds to the shape of the sidewall of the housing.

In this context, it is shown in particular in FIG. 5 that the base free-form surface 12 in the embodiment of FIG. 4 comprises a step. The course of the step corresponds to the folded bellows transition section 7. In this folded bellows transition section 7, a distance between two neighboring first fold edges 15, 16, 17 is different from a distance of neighboring second fold edges 18, 19, 20 in the first folded bellows section 4 and in the second folded bellows section 5. In the illustrated case, the distance between the first fold edges 15, 16, 17 is greater than the distance between the second fold edges 18, 19, 20. Thus, the folding of the folded bellows 2 across its folded bellows base surface varies in order to enable an adaptation to the given installation space structures. Moreover, it can be seen in FIG. 5 that the integration of installation or attachment parts, such as here the valve 21, can be realized more easily by the adaptation of the fold edge height or of the folding of the folded bellows 2. The folded bellows 2 is fastened by means of compression to the side free-form surface 13.

As a whole, the available height across the base free-form surface 12 is thus optimally utilized in the existing installation space. The filtering efficiency of the liquid filter 1 is improved. A filter surface area optimized in relation to the installation space is available. An improved separation efficiency can be achieved. The service life or the service interval of the liquid filter 1 can be prolonged.

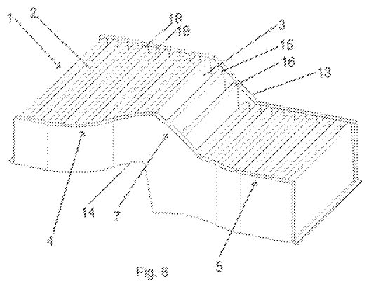

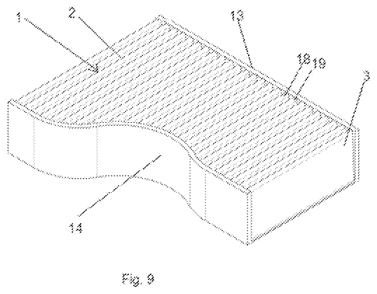

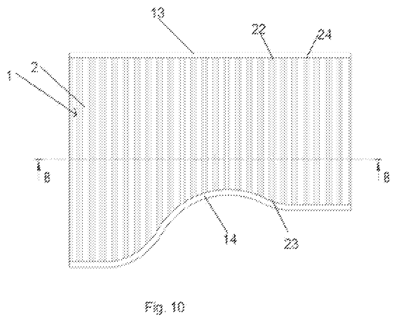

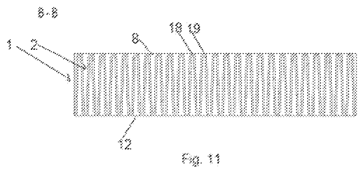

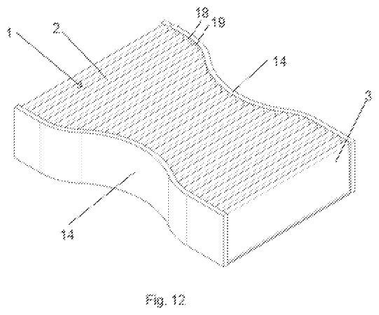

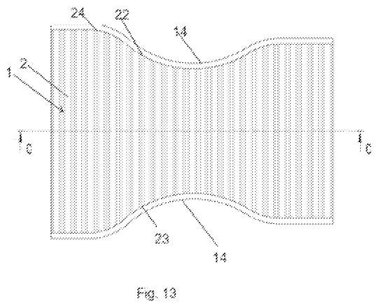

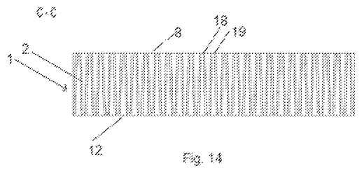

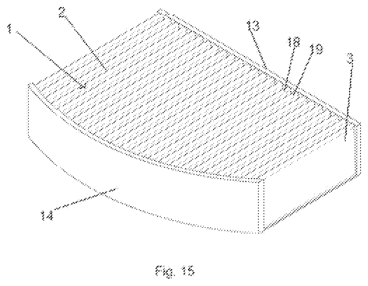

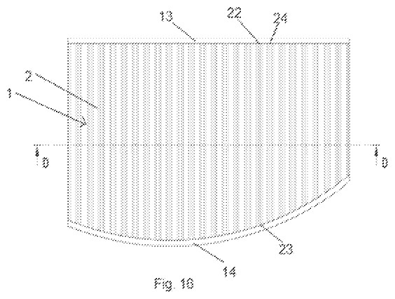

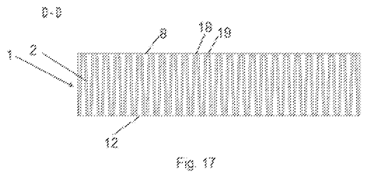

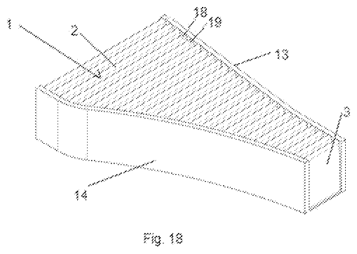

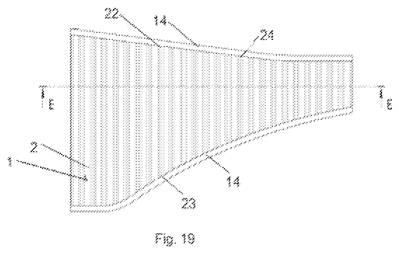

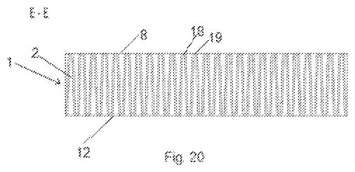

As a whole, alternatively to or in particular additionally to the optimized utilization of an installation space that is available and alternatively or additionally to the adaptation of the fold edge height across the base free-form surface 12, the folded bellows base surface itself can be adapted also. For this purpose, fold end faces 22, 23, 24 of the folded bellows 2 are adapted to a course of the side free-form surface 13 facing them and in particular to a curved side free-form surface section 14. This principle is illustrated in FIGS. 6 to 20.

In this context, FIGS. 6, 9, 12, 15, and 18 illustrate respectively a perspective illustration of the liquid filter 1 which is fitted into a side free-form surface 13 with at least one curved side free-form surface section 14. The illustrated side free-form surfaces 13 or side free-form surface sections 14 can be a lateral border of the folded bellows, e.g., in the form of a side band or a sidewall of a housing that is not completely illustrated. The contours corresponds always to those of the installation space.

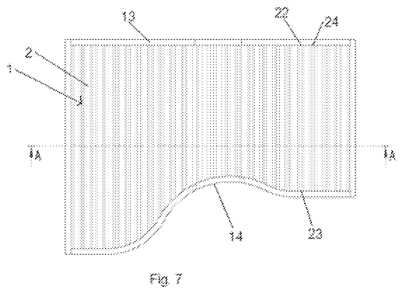

In FIGS. 7, 10, 13, 16, and 19, a respective plan view of the corresponding embodiments of the aforementioned FIGS. 6, 9, 12, 15, and 18 is then illustrated.

In this context, it can be in particular seen, respectively, that the folded bellows 2 with its folded bellows base surface completely and optimally fills out the base free-form surface 12, respectively. In this context, the fold end faces 22, 23, 24 are fastened respectively across the circumferential course of the contour of the base free-form surface 12 to the side free-form surface 13 or the curved side free-form surface section 14. This attachment can be realized by clamping, compressing, gluing, welding or embedding by injection molding the fold end faces 22, 23, 24 at the side free-form surface 13 or the curved side free-form surface section 14. Also, the folded bellows 2 can be assembled or framed by glued-on side bands. By a joining process (e.g., gluing, welding etc.), the folded bellows 2 with flexible configuration can then be introduced into a housing pot with sidewalls corresponding to the side free-form surface and installed in the installation space that is available.

As a whole, the available base free-form surface 12 in the existing installation space is optimally utilized by means of the folded bellows base surface. The filtering efficiency of the liquid filter 1 is improved. The pressure loss is minimized. A larger filter surface area is available. A better separation efficiency can be achieved. The service life or the service interval of the liquid filter 1 can be prolonged.

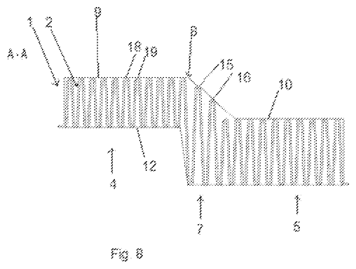

Finally, a section illustration of the FIGS. 7, 10, 13, 16, and 19 is illustrated in FIGS. 8, 11, 14, 17, and 20, respectively. It can be seen that the filter bellows 2 as a whole is adapted to the height of the installation space that is available as well as to the base free-form surface 12 that is available.

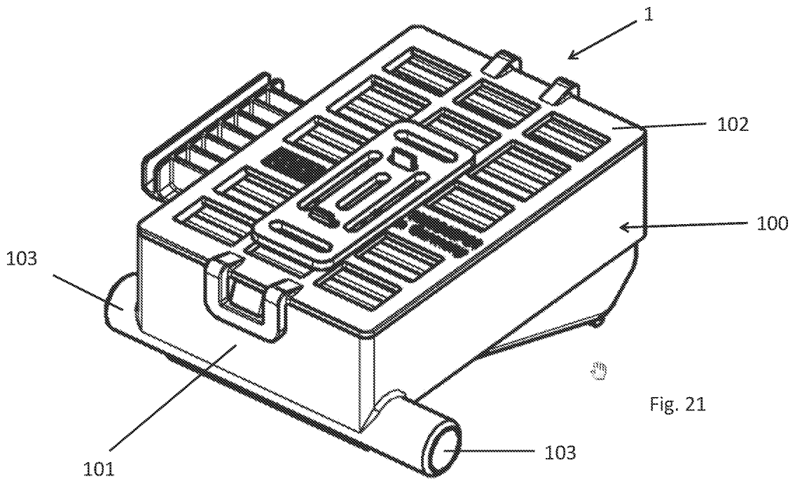

In FIG. 21, a filter 1 for an E-axle of an electric or hybrid vehicle is illustrated. The filter 1 serves for filtration of transmission oil of a transmission of the E-axle. The filter 1 is embodied for pressureless use without pump, i.e., the transmission oil is not conveyed by a pump to the filter 1 and not forced by pressure or sucked through the filter medium. The filter 1 comprises correspondingly a housing 100 that is open at the inflow side, with a housing pot 101 which is closed by a cover 102 embodied as a grid. The oil can pass across the entire cover region to the folded bellows 2 in the interior of the housing 100. The cover 102 is fastened at the housing pot 101 by means of a snap connection. The filter element is configured as a folded bellows 2 with fold end faces framed by a side band and is inserted into the housing pot 101, wherein the side bands form the longitudinal seal to the housing pot 101. The rim folds can be compressed for transverse sealing between housing pot 101 and cover 102. An additional sealing action, for example, by means of a circumferential sealing ring as in air filter elements is not required. By eliminating a pump, the oil is forced only by the force of gravity through the filter medium. The folded bellows 2 is therefore exposed only to a minimal pressure (that created by the oil itself) and must be protected at most only minimally against deformation. The transmission oil can be supplied through the grid uniformly to the inflow side of the filter element. By the folding, a plurality of intermediate spaces are formed in which the supplied oil can collect so that, in contrast to a configuration with a foam-type filter medium, slopover from the filter housing 100 is avoided. The filtered oil can exit through one or a plurality of outlets 103 in the filter pot 101 from the filter 1 and be supplied to the required locations, for example, a bearing. A vent opening by means of which air located in the closed space between folded bellows 2 and housing pot 101 can escape is not illustrated. Alternatively, the filter bellows 2 can be glued fixedly in the housing pot 101. In this case, no cover is required in order to secure the filter element. The filter 1 comprises then a housing without cover.

The illustrated filter housing with rectangular shape is to be understood as a principal illustration for a housing for a folded bellows for use without pump. Corresponding to the existing installation space, the sidewalls, the bottom surface, and/or the cover will have a contour or shape that is correspondingly adapted.

What is claimed is:

1. A liquid filter for filtering a liquid, the liquid filter comprising:
a raw-side inflow face and a clean-side outflow face;
a throughflow path connecting the raw-side inflow face and the clean-side outflow face to each other;
a filter body comprising a filter medium folded to a folded bellows comprising folds including two rim folds, wherein the folded bellows is of a one-piece configuration;
each fold comprising a first fold sheet and a second fold sheet, wherein the first and second fold sheets adjoin each other at a fold edge;
each fold comprising two oppositely positioned fold end faces;
wherein the filter body is configured to be installed in an pre-defined installation space vehicle which delimits and defines an installation space volume by a base free-form surface having a shape, a cover free-form surface having a shape, and a side free-form surface having a shape;
wherein the folds comprises a fold edge height, respectively, and the fold edge heights are adapted to an uneven or slanted course of a contour of the cover free-form surface; of the base free-form surface; or of the cover free-form surface and of the base free-form surface;
wherein the folds include one or more first folds with a first fold edge height and one or more second folds with a second fold edge height, wherein the first fold edge height and the second fold edge height differ from each other;
wherein the folds include third folds whose fold end faces are adapted to a course of a contour of the side free-form surface facing the fold end faces of the third folds;
wherein a shape of an envelope extending around all of the fold end faces and around the two rim folds deviates from a rectangle.

2. The liquid filter according to claim 1, wherein
the folded bellows (2) is arranged in and installed into a housing pot (101) having a sidewall and a bottom surface, wherein a shape of the sidewall corresponds to the shape of the side free-form surface (13), and wherein a shape of the bottom surface corresponds to the shape of the base free-form surface (12).

3. The liquid filter according to claim 2, further comprising a housing cover to be connect to the housing pot.

4. The liquid filter according to claim 3, wherein the housing cover is embodied as a grid or the housing cover is configured to close the housing pot and comprises a configuration adapted to the cover free-form surface.

5. The liquid filter according to claim 2, wherein at least one of the folds arranged at the raw-side inflow face and/or at the clean-side outflow face is fastened to the sidewall, respectively, by clamping, compressing, gluing or welding.

6. The liquid filter according to claim 2, wherein at least one of the fold end faces is fastened to the sidewall, respectively, by clamping, compressing, gluing or welding.

7. The liquid filter according to claim 2, wherein at least one of the folds arranged at the raw-side inflow face and/or at the clean-side outflow face is fastened to the sidewall, respectively, by clamping, compressing, gluing or welding and wherein at least one of the fold end faces is fastened to the sidewall, respectively, by clamping, compressing, gluing or welding.

8. The liquid filter according to claim 1, wherein the folded bellows comprises at least two folded bellows sections, wherein the at least two folded bellows sections include a first folded bellows section provided with the first folds, wherein the at least two folded bellows sections include a second folded bellows section provided with the second folds, wherein the first fold edge height of the first folds and the second fold edge height of the second folds are configured to leave unoccupied a first predetermined distance in the first folded bellows section and a second predetermined distance in the second folded bellows section, respectively, in relation to the cover free-form surface and/or a housing cover of a housing pot of the liquid filter.

9. The liquid filter according to claim 8, wherein the at least two folded bellows sections include a folded bellows transition section arranged between the first folded bellows section and the second folded bellows section, wherein a distance between two neighboring fold edges of the folds of the folded bellows transition section is different from a distance between two neighboring fold edges of the first folds of the first folded bellows section or of the second folds of the second folded bellows section.

10. The liquid filter according to claim 1, wherein the folded bellows comprises at least two folded bellows sections, wherein the at least two folded bellows sections include a first folded bellows section provided with the first folds, wherein the at least two folded bellows sections include a second folded bellows section provided with the second folds, wherein the first fold edge height of the first folds and the second fold edge height of the second folds are configured to leave unoccupied a first predetermined distance in the first folded bellows section and a second predetermined distance in the second folded bellows section, respectively, in relation to the base free-form surface and/or a bottom surface of a housing pot of the liquid filter

11. The liquid filter according to claim 10, wherein the at least two folded bellows sections include a folded bellows transition section arranged between the first folded bellows section and the second folded bellows section, wherein a distance between two neighboring fold edges of the folds of the folded bellows transition section is different from a distance between two neighboring fold edges of the first folds of the first folded bellows section or of the second folds of the second folded bellows section.

12. The liquid filter according to claim 1, wherein the envelope comprises an envelope portion extending along all of the fold end faces, wherein the envelope portion comprises at least one curved section adapted to a curved side free-form surface section of the side free-form surface.

13. The liquid filter according to claim 1, wherein the folded bellows is formed continuously of a single material.

14. The liquid filter according to claim 1, wherein the fold edge heights lie in a range between 2 mm to 100 mm.

15. The liquid filter according to claim 14, wherein the fold edge heights lie in a range between 4 mm to 80 mm

16. The liquid filter according to claim 15, wherein the fold edge heights lie in a range between 8 mm and 50 mm.

17. The liquid filter according to claim 1, configured as a transmission oil filter.

18. The liquid filter according to claim 1, configured as a pressureless transmission oil filter.

19. An E-axle for a vehicle, the E-axle comprising a transmission and a liquid filter according to claim 1 for filtering transmission oil of the transmission.
